(19) United States
(12) Patent Application Publication
(10) Pub. No.: US 2004/0258567 A1
(43) Pub. Date: Dec. 23, 2004

(54) Device and method for monitoring and illuminating a fluid

(76) Inventors: Daniel E. Kokin, San Francisco, CA (US); Christopher M. Alexander, San Mateo, CA (US)

Correspondence Address: William J. Kolegraff, 3119 Turnberry Way, Jamul, CA, 91935, US

(21) Appl. No.: 10/464,940

(22) Filed: Jun. 19, 2003

(51) Int. Cl. G01N 15/06

(52) U.S. Cl. 422/68.1

(57) ABSTRACT

A plumbing fixture is provided to monitor and dispense a fluid in an illuminated fluid stream. The fixture includes a sensor in or adjacent the fluid path for sensing a water condition, such as fluid flow, temperature, volume, or contamination. Processing circuitry couples with the sensor and generates a message indicative of the water condition. Activation circuitry activates a light source to present the message to a user of the plumbing fixture. For example, the activation circuitry may select particular colors, patterns, or intensity of the light to inform a user of a fluid condition. The light source directs its generated light beam into the fluid path to illuminate the fluid stream and a localized area. In a particular example, the monitoring and illuminating device is attached to a water faucet to illuminate a water stream and to indicate that the water stream is in a safe temperature range.

### BACKGROUND

The field of the present invention is plumbing fixtures. More particularly, the present invention relates to plumbing fixtures having an integrated sensor and light source.

Plumbing fixtures are ubiquitous in our everyday world. Plumbing fixtures are used to transport fluids from a source to a user, and may be used to make the fluid useful for residential, commercial, or industrial uses. In one use, plumbing fixtures are useful for dispensing fluids. For example, faucets are used to dispense water into a sink, bath, or other basin; shower heads are used to spray water; and spray guns are used to flexibly disperse a fluid over a large area. Each of these fixtures has a port for dispensing a fluid from a fluid distribution system. The most common fluid distribution system is a water distribution system; although other types of water distribution systems may be used. For example, a soda dispenser is used for dispensing a drinkable fluid into a container, such as a drinking cup.

In providing plumbing fixtures, particularly plumbing fixtures for dispensing fluids, three problems have emerged. First, it has proven particularly difficult to illuminate the area immediately adjacent the dispensed fluid. Second, it is difficult to obtain information regarding the condition of fluid. And third, it has been a struggle to make dispensing fixtures aesthetically pleasing.

With known plumbing fixtures, external lights are often used to illuminate the area immediately adjacent the dispensed fluid. For example, bright bathroom lights are generally used to illuminate hands being washed in a water stream. In another example, bright kitchen spot-lighting may be used to illuminate dishes being rinsed in flowing water. However, such spot lighting is generally ineffective as a person's hands or other obstruction often interfere with illumination. Further, such spot lighting is also generally ineffective in illuminating surface areas when using the kitchen spray gun. When the spray gun is used to rinse out the inside of a pan, it is unlikely that the spot lighting reaches the interior surfaces being cleaned. To compensate, the user must rinse out the pan, invert the pan so that its interior surface is illuminated, and visually check that washing and rinsing is complete. In another example, a shower stall often is dimly lit, and known overhead lighting is unable to provide illumination where desired.

The second problem with known plumbing fixtures is that little to no information regarding the condition of the fluid may be readily presented to the user. In obtaining such information, a user has typically had to rely upon either touching the fluid or the use external devices. For example, in testing the temperature of a water stream dispensed from a faucet, a user often quickly passes a finger through the water stream to check its temperature. Alternatively, the user may use a thermometer to verify a desired temperature or temperature range. To compensate, some faucets have included temperature gauges to provide a visual readout of temperature. Often, however, such temperature gauges take too long to settle and read an accurate temperature. In this regard, a temperature gauge may indicate a safe temperature, but the actual water stream may be much hotter as the gauge may not yet have settled. In another example, the gauges are replaced with a digital indicator for displaying temperature. Although more responsive than the gauge, such an arrangement is difficult to build into a pleasing ornamental design.

It has also proven difficult to make dispensing plumbing fixtures aesthetically pleasing. The plumbing industry expands substantial resources in designing, manufacturing, and marketing new and pleasing fixture designs. Incorporating a pleasing aesthetic design into plumbing fixtures is particularly difficult as plumbing fixtures generally have a utilitarian purpose. For example, a bathroom faucet will have to withstand extended wear-and-tear in dispensing water for washing of hands. The bathroom faucet also preferably is visually attractive and complements the chosen decor for the bathroom. Further, it would be highly desirable that the bathroom faucets be easy to clean, easy to maintain, and affordable.

### SUMMARY

It is therefore desirable to provide a new device and method for monitoring and illuminating a fluid in an aesthetically pleasing way. Briefly, the present invention provides a plumbing fixture that dispenses a fluid in a fluid stream. The fixture includes a sensor in or adjacent the fluid path for sensing a water condition, such as fluid flow, temperature, volume, or contamination. Processing circuitry, coupled with the sensor, generates a message indicative of the water condition. Activation circuitry activates a light source to present the message to a user of the plumbing fixture. For example, the activation circuitry may select particular colors, patterns, or intensity of the light to inform a user of a fluid's attributes. The light source directs its generated light beam into the fluid path to illuminate the fluid stream and a localized area. In a particular example, the monitoring and illuminating device is attached to a water faucet to illuminate a water stream and to indicate that the water stream is in a safe temperature range.

Advantageously, the disclosed monitoring and illumination device provides a user with valuable information concerning the dispensed fluid. For example, the user may be presented with information regarding the fluid temperature, volume, or contamination condition prior to the user contacting the fluid. Further, the monitoring and illumination device provides desirable illumination of the water stream and of the area immediately surrounding the water stream. In one example of the device, if the water stream is directed at a cleaning surface, the cleaning surface may also be illuminated. Finally, the monitoring and illumination device provides a very aesthetically pleasing appearance to a faucet and water stream. It has been found that an aerated water stream is particularly well suited for illumination, and provides a uniquely pleasing aesthetic quality. In this way, even a moderately priced plumbing fixture may provide a particularly pleasing and modern appearance.

### BRIEF DESCRIPTION OF THE DRAWINGS

FIG. 1 is a device for monitoring and illuminating a fluid in accordance with the present invention;

FIG. 2 is a block diagram of a device for monitoring and illuminating a fluid in accordance with the present invention;

FIG. 3 is a flowchart of a method for monitoring and illuminating a fluid in accordance with the present invention;

FIG. 4 is a block diagram of a device for monitoring and illuminating a fluid in accordance with the present invention;

FIG. 5 is a flowchart of a method for monitoring and illuminating a fluid in accordance with the present invention;

FIG. 6 is an illustration of a active aerator in accordance with the present invention;

FIG. 7 is an exploded view of an active aerator in accordance with the present invention;

FIG. 8 is a cross sectional view of an active aerator in accordance with the present invention;

FIG. 9 is an illustration of LED positions in accordance with the present invention;

FIG. 10 is an illustration of an external aerator in accordance with the present invention;

FIG. 11 is an illustration of an attachable aerator in accordance with the present invention;

FIG. 12 is a device for monitoring and illuminating a fluid in accordance with the present invention;

FIG. 13. is an illustration of an attachable aerator in accordance with the present invention;

FIG. 14 is an illustration of a rotatable attachable aerator in accordance with the present invention;

FIG. 15 is a diagram of the rotatable attachable aerator of FIG. 14;

FIG. 16 is an illustration of the rotatable attachable aerator of FIG. 14 coupled to a water faucet;

FIG. 17 is an illustration of the rotatable attachable aerator of FIG. 14 coupled to a water faucet;

FIG. 18 is a diagram of an activation circuit in accordance with the present invention; and

FIG. 19 is a diagram of a plumbing fixture in the form of a water filter in accordance with the present invention.

### DETAILED DESCRIPTION

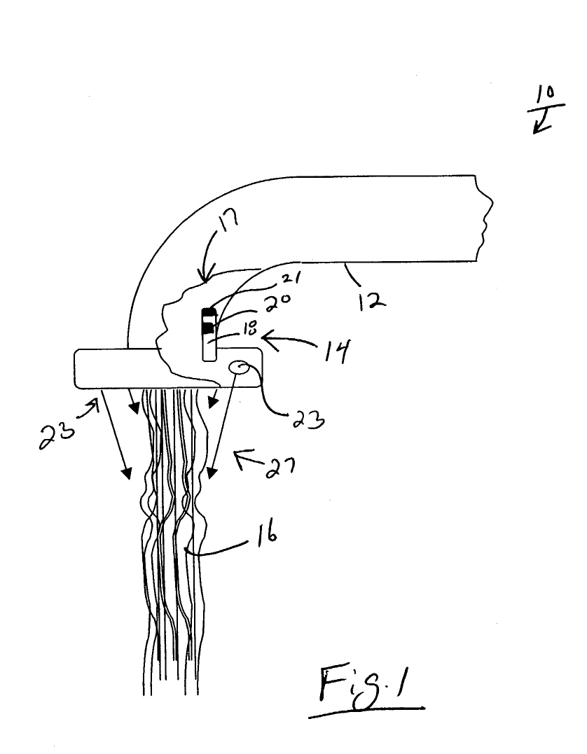

Referring now to FIG. 1, a device for monitoring and illuminating a fluid is shown. Device 10 is illustrated as a water faucet. However, it will be appreciated that other plumbing fixtures may be substituted, for example, showerheads and spray guns. It will also be appreciated that alternative fluids may be used, such as a soft-drink fluid flowing through a drink dispenser head. Device 10 comprises a plumbing fixture 14, which has a fluid inlet 12 for dispensing a fluid stream 16 from a port in the fixture 14. It will be appreciated that on-off controls or volume controls may be coupled to the fluid inlet 12

The device 10 monitors the condition of the fluid, and illuminates the fluid stream in a useful and aesthetically pleasing manner. In this way, the fluid stream provides a user with a visual indication of a water condition, such as the temperature of the fluid. In a simplified construction, the illumination is used to indicate that fluid is flowing and to illuminate the fluid stream in a localized area. The device 10 may be used in residential, commercial, and industrial applications where monitoring and illumination of fluid is desirable or useful. The device 10 may be integrated into new plumbing fixtures, or may be provided as an attachment in retrofit applications. In one example, the device 10 provides illumination into an aerated water stream, which is particularly useful and aesthetically appealing.

Fixture 14 is illustrated with a cutaway portion 17 for ease of explanation. Integrally positioned in the fixture 14 is a control module 18. The control module may include one or more sensors, such as a sensor 20 and a sensor 21. The control module 18 may also be coupled to a power source, such as an internal or external battery module (not shown). Sensor 20 may used to detect a condition of the fluid. For example, sensor 20 may be constructed as a temperature sensor, a volume sensor, or a contaminate sensor. In this way, sensor 20 may detect a particular characteristic of the fluid about to be dispensed as fluid stream 16. In particular applications, it may be useful or necessary to inform a user of the status of one or more of these conditions. In another example, the sensor may be external to the water stream, and provide other information to the user. For example, the sensor may be a timer that senses how long the water has been running, or may even sense an absolute time. In another example, the sensor may couple to another device, such as a computer or telephone, to sense when an electronic message is being received. In this way, the fluid stream may be illuminated to indicate such external characteristics such as time, a door bell ring, or a telephone call.

In one arrangement of the fixture 14, the control module 18 includes processing circuitry for preparing a message regarding the water condition. For example, the sensor 20 may detect a particular temperature of the fluid, and the processing circuitry may prepare a message that the fluid is in a safe temperature range. In another example, the sensor 20 may detect a particular contaminate in the fluid, such as a bacteria or chemical, and the processing circuitry may generate a message indicative of a dangerous contamination condition. Control module 18 may also contain activation circuitry for activating one or more light sources, such as light source 23. The light source 23 may be activated in response to the water condition sensed by sensor 20. Alternatively, a flow sensor 21 may be arranged to detect the presence of flowing fluid. In this way, the light source 23 would not activate until the fluid sensor 21 detects fluid flowing. Upon detecting a fluid flow, the light source 23 may be activated to present the message regarding fluid condition. Preferably, light source 23 generates an illumination beam 27, which is directed into the fluid stream 16. Light source 23 may be, for example, an LED, or another type of lamp. Light source 23 may also be arranged as a single illumination lamp, or may comprise several lamps. Further, it will be appreciated that light source 23 may be arranged external to the fluid stream 16, as illustrated, or the light source may be provided within the fluid stream. In either arrangement, the light beam generated by the light source 23 is directed into the fluid stream.

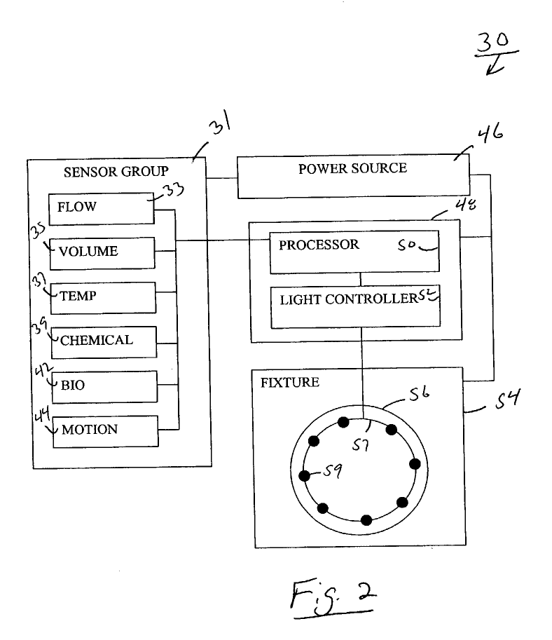

Referring now to FIG. 2 a block diagram of a device for monitoring and illuminating a fluid is shown. Device 30 has a sensor group 31 useful for detecting one or more conditions present in the fluid. These sensors may include, for example, a flow sensor 33 to determine if fluid is flowing or not flowing through the device. Other sensors may include a volume sensor 35 for measuring the volume of fluid flowing past the sensor. A temperature sensor 37 may be arranged to measure the temperature of the fluid. In particular applications, it may be desirable to measure contaminants in the fluid. In this regard, a chemical sensor 39 or a biological sensor 42 may be used to detect specific contaminants.

Also, some applications may benefit from a motion sensor 44 that is capable of detecting levels of turbulence in a fixture. In another example, the motion sensor may be used to detect a movement through the fluid stream, such as when someone is washing their hands, to enable the device to provide different illumination when movement occurs. Such a motion sensor may be, for example, an IR (infra-red) detector for detecting the movement of a heat-emitting body. It will be appreciated that other types of sensors may be used to detect other specific conditions present in the fluid. The sensors will be constructed to be compatible with the particular fluid used in the fixture, and designed to detect a particular condition of the fluid. The design and manufacturing of sensors is well known, so will not be discussed in detail.

In another example of the sensor circuit, the sensor may be responsive to other parts of the plumbing fixture or control system. In this way, the position of an on/off valve may be used to sense fluid flow and even estimate fluid volume. In a fixture having an automatic shut-off feature, such as many motion-activated fixtures, the on-off circuitry of the fixture could provide a signal for changing the illumination of the water stream to warn the user that the water is about to stop flowing. By way of illustration, when the on-off circuitry is about to turn off the water flow, the on-off circuitry could send an “off” signal to a sensor, and the sensor and control circuitry would cause the illumination beam to flash, thereby warning the user the water flow is about to stop. It will be appreciated that other light colors, rates, and intensities may be used to inform the user.

Device 30 also includes a power source 46. The power source may be, for example, a battery module, a transformer for coupling to an AC power grid, or even an electromagnetic generator. If the power source 46 is an electromagnetic generator, the power source may still require a small battery module for providing standby power. In this way, device 30 may continue certain monitoring and standby functions when fluid is not flowing. When the fluid flow becomes strong enough to activate the electromagnetic generator, then the power from the electromagnetic generator may be used to power device 30 and to recharge the battery if recharging circuitry is provided.

Device 30 also comprises electronic circuitry 48. Electronic circuitry 48 may include processing circuitry 50 and activation circuitry 52. Electronic circuitry 48 is powered by power source 46 and receives sensory input from sensor group 31. Processor 50 may be constructed as a microprocessor, microcomputer, or discrete circuitry. It will be appreciated that other configurations for the processor may be used. For example, the processor may be arranged as a programmable logic device or a gate array. The processor couples to one or more of the sensors in the sensor group 31 and is used to interpret the measurements taken by the sensor. The processor 50 may also be coupled to user controls (not shown) for receiving input from a user. The user may set, for example, the acceptable ranges for fluid temperature. The processor 50 then compares the measurements from the sensor to predefined criteria, and generates a message indicative of the fluid condition. For example, the processor may obtain a measurement indicating the current fluid temperature from temperature sensor 37. The processor 50 compares the temperature measurement to predefined temperature ranges and generates a message indicating the fluid temperature. This message may indicate the fluid is in a cold range, a preferred range, or a hot range. It will be appreciated that the specific messages may be structured to satisfy the needs of particular applications and users.

Electronic circuitry 48 also includes the light controller 52. Depending on the type of illumination required, the light controller 52 may be arranged for example, as a switch, a processor, a programmable logic device, or a gate array. In a simple example, the light controller 52 is a switch that, responsive to a sensor such as the flow sensor 33, activates the light source 57. In a more sophisticated example, the light controller accepts an instruction from processor 50, and selects a particular color in which to generate a light beam. Such a selection could be made by selecting the particular color output for a multicolor lamp, or may select a particularly colored lamp or set of colored lamps for illumination. In another example, light controller 52 accepts a message from processor 50 and generates a pattern to be applied to a light beam. For example the light beam may be made to flash in a particular cadence to indicate a condition of the fluid. It will be appreciated that light controller 52 may be constructed to activate lamps in alternative ways, such as by varying intensity.

Device 30 also includes a fixture 54. Fixture 54 may be, for example, a faucet, a spray gun, a drinking fountain, or a showerhead. Fixture 54 includes a fluid port 56 where the fluid is dispensed in a fluid stream. A light source 57 is arranged adjacent to the fluid stream and positioned to direct its light beam into the fluid stream. It will be appreciated that the light source 57 may be positioned in the fluid stream (as shown) or external to the fluid stream. The light source 57 includes one or more lamps 59 for generating a light beam. It will be appreciated that each of the lamps may be the same, or different lamps may be provided for providing a different characteristics to the light beam.

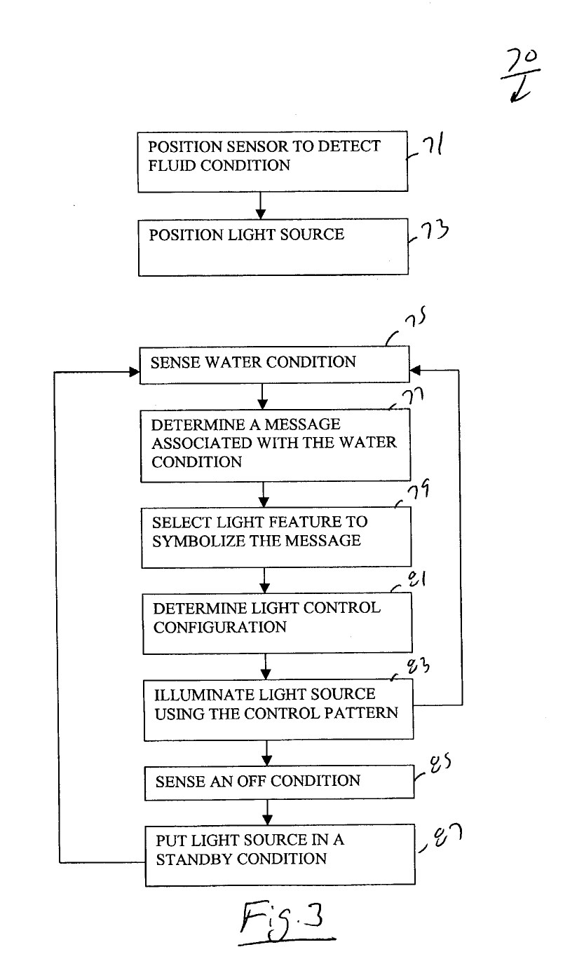

Referring now to FIG. 3, a method for monitoring and illuminating a fluid is illustrated. Although the method of FIG. 3 uses water as the selected fluid, it will be appreciated that other fluids may be substituted. Method 70 positions a sensor in block 71 to detect a fluid condition. Such a sensor may be, for example, a flow sensor, a volume sensor, a temperature sensor, or a contamination sensor. It will be appreciated that some sensors are constructed to be inserted into the fluid path, while some sensors may be provided external to the fluid path. For example, some known flow detectors may be attached on the outside of piping carrying the fluid of interest. In block 73, a light source is positioned to direct its generated light beam into a fluid path. For example, a light source may generate a light beam, with the light beam directed into the water stream as the water is dispensed from the faucet.

In operation, a water condition is sensed as shown in block 75. The water condition is sensed using one or more of the sensors, and the sensed water condition is used to determine a message to associate with the fluid condition as shown in block 77. For example, the water condition may be a temperature, and the message may indicate whether the water is in a too high, too low, or safe range. It will be appreciated that any number of messages may be constructed depending upon application specific needs. Once the message has been determined, a light feature is selected and configured to symbolize the message as shown in blocks 79 and 81. The light feature may be a particular color, a particular illumination level, a pattern, or any combination of the above. In its simplest form, the light feature may merely be to provide illumination when water flows, and not to illuminate when water does not flow, with the message being an indication of water flow. More sophisticated color selection, pattern cadences, and intensity variations may be used to provide more information to the user.

The light source is then illuminated in block 83. Often, it will be useful to illuminate the light source responsive to one of the sensed conditions. For example, illumination may be responsive to the detection of fluid flow. In this way, the light source would be off when no fluid is flowing, and the light source would be activated when fluid is flowing. In another example, the light is activated when the dispensed fluid is in a safe temperature range, and off when the fluid is in an unsafe range. In this way, a user knows to touch or use the fluid stream only when the fluid stream is illuminated. In this way, the activation of the light source is dependent on both fluid flowing and the fluid being in a proper temperature range. It will be appreciated that numerous combinations of criteria and sensors may be used for activating the light source.

In block 85 an off condition is sensed. Often, the off condition will be the cessation all of fluid flow. In other cases, the off condition may be provided by a sensor sensing a water condition that is in or out of a particular range condition. Accordingly, the presence of illumination provides an indication of fluid condition. Once the off condition has been received, then be light source is placed in a standby condition as shown in block 87. The standby condition is intended to minimize power usage to conserve power. In one example, the circuitry remains in an off state until a fluid flow is detected. In one such construction, a physical switch is used to detect the flow of fluid so that the circuit only activates when fluid is flowing. Alternatively the circuit may be placed in a standby state until a fluid flow is detected. In this way, a minimal amount of the circuitry is activated for flow detection purposes. The remaining circuitry is activated after flow is detected.

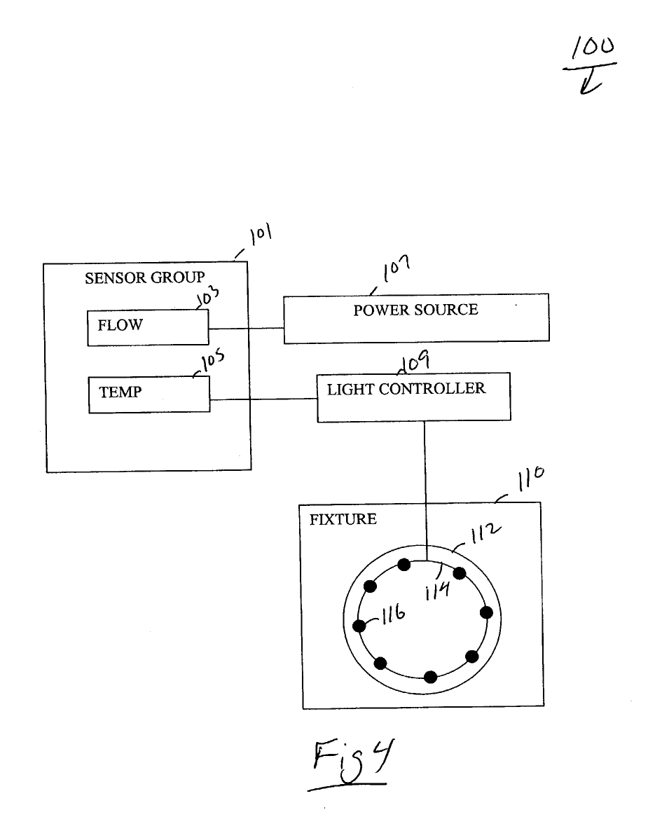

Referring now to FIG. 4, a device for monitoring and illuminating a fluid is shown. Device 100 is constructed to visually inform a user of a temperature of water flowing from a water faucet. It will be appreciated that other applications, water conditions, and fluids may be used. Device 100 includes a sensor group 101 that has two sensors. A flow sensor 103 is used to indicate whether fluid is flowing through a faucet. A second sensor 105 is used to detect a temperature of the water just prior to being dispensed from the faucet. The flow sensor 103 is coupled to a power source 107. In one example, the power source 107 is a battery module. The battery module may be internal to the faucet, or may be externally positioned for ease of access. The power source 107 may selectively activate power to the device 100 responsive to flow detection by the flow sensor 103. In a simple form, the flow detector 103 is a switch for switching the power source 107, thereby acting as activation circuitry for the device 100. In this way, no power is needed in the device 100 until the physical switch is activated to activate the power source 107. Once the power source 107 is activated, then the temperature may be sensed at temperature sensor 105 with an indication of temperature passed to the light controller 109.

Light controller 109 receives an indication of temperature from temperature sensor 105, and is powered by power source 107. The light controller acts as processing circuitry to determine the message to be presented to the user and for selecting and activating the light source 114. The light controller may be, for example, a microprocessor, a programmable logic device, a gate array, or discrete components. In its simplest form, the light controller may be a switch for merely activating and deactivating the light source 114, or the light controller may be a more sophisticated processor for constructing messages using colors, intensities, or patterns.

The light controller couples to a light source 114, which comprises one or more lamps 116. Lamps 116 may be, for example LED's. The light source 114 may be positioned within the water port 112, or may be positioned external to the water port, provided the generated light beam is directed into the water stream. In one advantageous arrangement, the light beam is directed into an aerated water stream, which provides a very appealing visual quality. The water port 112 is positioned on a fixture 110, such as a faucet. The entire device 100 may be constructed integrally to the faucet, or may be provided as a removable attachment or aerator to the faucet.

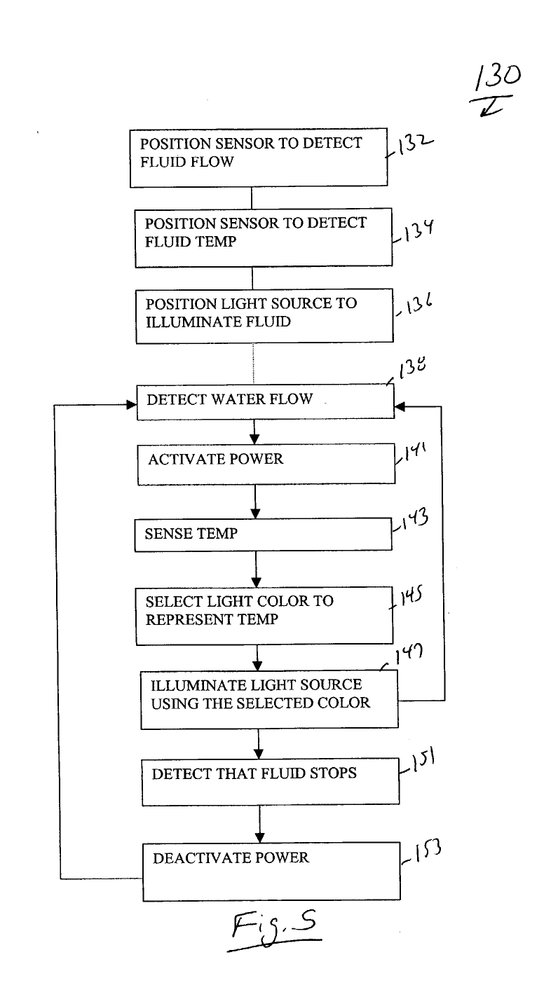

Referring now to FIG. 5, a method for monitoring and illuminating a fluid is illustrated. Method 130 starts by positioning at least one sensor to detect fluid flow as shown in block 132. Another sensor may be positioned to detect fluid temperature as shown in block 134. A light source is also positioned on the plumbing fixture to illuminate fluid as it is dispensed from the plumbing fixture as shown in block 136. In operation, a water flow is detected as shown in block 138. Upon detecting water flow, power is activated as shown in block 141. Once power has been activated, the temperature may be sensed as shown in block 143. Processing circuitry is then used to select the appropriate color to represent the sensed temperature as shown in block 145. For example, a red color may be selected if the temperature is in an unsafe range, while a green color may be selected if the temperature is in a safe range. It will be appreciated that other colors, intensities, and patterns may be selected to present the condition of the water temperature. In block 147, the light source is illuminated using the color or other indictor selected in block 145. The light source generates a light beam, and the light beam has been directed in to the fluid stream. In this way, the fluid stream is illuminated to provide localized illumination and an aesthetically pleasing appearance. As long as water continues to flow, the method 130 continues to monitor the temperature of the water, and to indicate the current temperature using selected colors. Accordingly, the method 130 provides nearly immediate visual notification to a user of the current temperature of the flowing water.

When the fluid stops flowing, the flow sensor detects the cessation of flow as shown in block 151. When the fluid has stopped flowing, then power may be deactivated as shown in block 153. Power is deactivated to conserve power. In a simple arrangement, the water flow is detected using a switch that acts to activate and deactivate the power according to whether fluid is flowing.

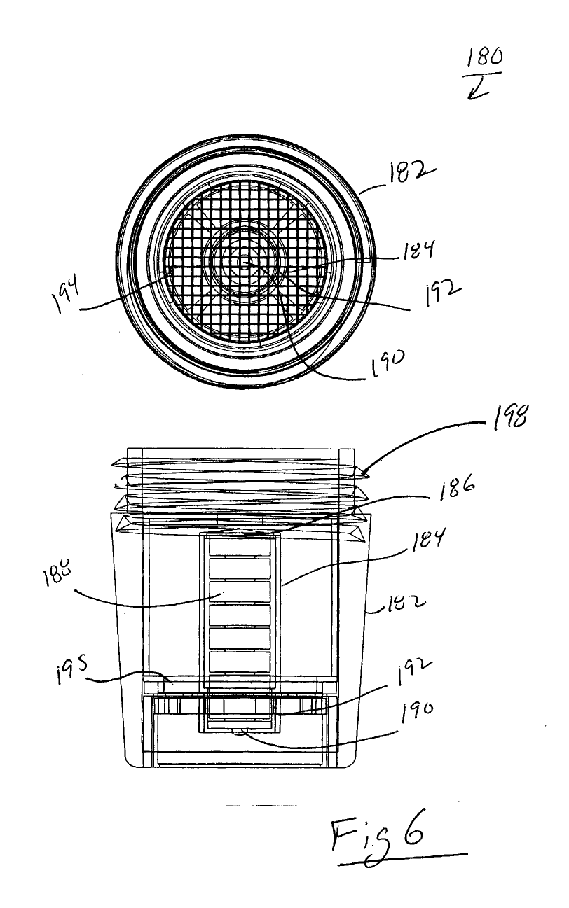

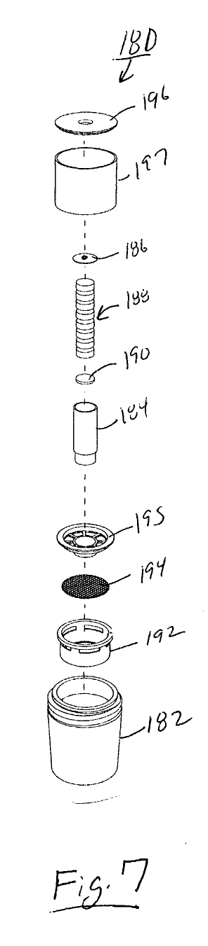

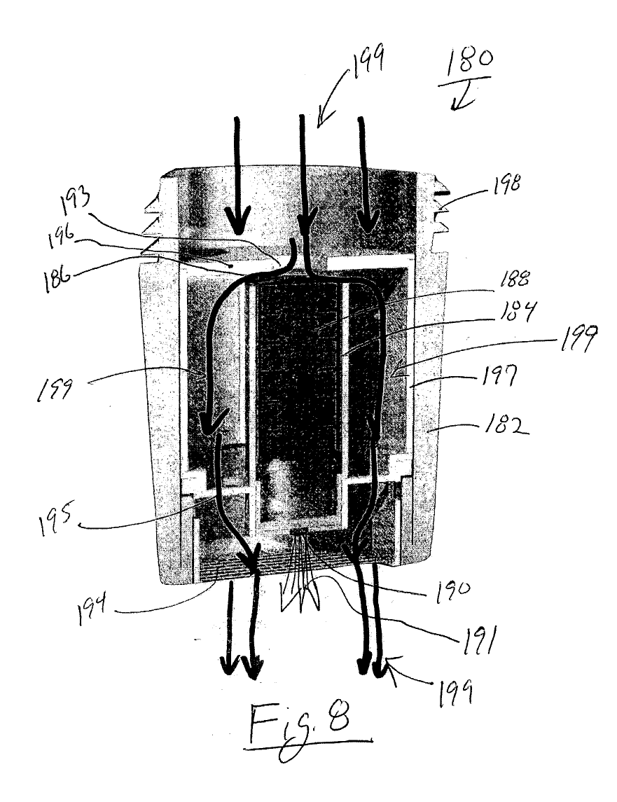

Referring now to FIGS. 6, 7, and 8, an active aerator 180 is illustrated. FIG. 6 shows the active aerator 180 in a bottom view and in a wire-frame side view. FIG. 7 shows the active aerator 180 in an exploded view, while FIG. 8 shows the active aerator 180 in a side cross-sectional view. The active aerator 180 is constructed to be threaded to a standard water faucet. It will be appreciated that the active aerator 180 may attach to a faucet in alternative ways, and could also be integrally formed in or on the faucet. However, as illustrated, the active aerator 180 may be conveniently attached to existing faucet installations. The active aerator 180 has a housing 182 having threads 198 constructed to mate with complementary threading on a faucet. In an alternative attachment method, the active aerator 180 could include a sealable port for slidably and frictionally receiving a faucet. It will be appreciated that other attachment methods may be used.

Active aerator 180 has a body 197 received into the housing 182. The body 197 has a cap 196 at one end and an aerator 195 at the other end. The aerator 195 cooperates with a screen 194 and an aerator body 192 to provide an aerator effect for the water stream. An aerator effect inserts air bubbles into the water stream to reduce splashing and to give the water stream additional cleansing power. An internal housing 184 is positioned concentrically within the body 197. The internal housing 184 is constructed to hold one or more batteries 188. These batteries may be, for example, standard available batteries, rechargeable batteries, watch batteries, or other type of battery module. A pressure sensitive cap 186 is positioned above the batteries, while an LED lamp is positioned below the battery. A cap 186, batteries 188, and LED 190 are held in the internal housing 184. The internal housing 184 also holds and activation circuit coupling the pressure sensitive cap 186 to the LED 190. With no or very low pressure applied to the pressure sensitive cap 186, the activation circuit remains in an open state. When additional fluid pressure is applied to the cap 186, the activation circuit is closed, thereby providing power to the LED 190. In this way the cap 186 acts to sense the flow of fluid, an LED generates a light beam responsive to pressure being applied to cap 186.

The internal housing 184 rests on the aerator 195 and directs the light beam 191 generated by the LED 190 through the screen 194. In operation, as shown in FIG. 8, the water flows through the active aerator 180 in water path 199. More specifically, water is received into the active aerator 180 and directed through inlet 193. The water presses against pressure cap 186 and flows between the body 197 and the internal housing 184. The water then flows through the aerator 195 and is dispensed from the active aerator through the screen 194. The dispensed water then forms a water stream, which may be received into a sink basin, for example. The light beam 191 is directed into the water stream for illuminating the water stream and a localized area around the water stream. In this way the water stream is illuminated and aesthetically pleasing.

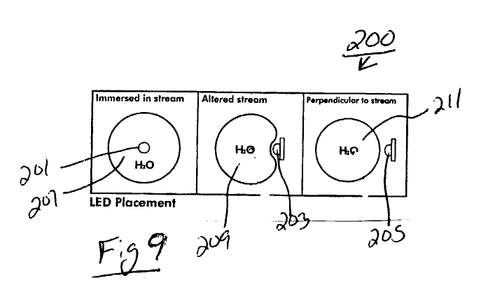

Referring now to FIG. 9, an illustration of example LED positions is shown. Positions 200 include having the LED 201 positioned within the fluid stream 207. In this regard, the position of the LED 201 is similar to the position of the LED shown with regard to active aerator 180 in FIG. 8. In an alternative position, LED 205 is positioned external to the fluid stream 211. Even though the LED 205 is external to the fluid pattern 211, the light beam generated by LED 205 is directed into the fluid pattern 211. Accordingly, LED 205 illuminates the fluid pattern and a localized area. In another alternative, LED 203 is positioned to disrupt the outer portion of fluid pattern 209. In a similar manner, the light beam generated by LED 203 is directed into the fluid pattern 209 to illuminate the fluid stream and a localized area.

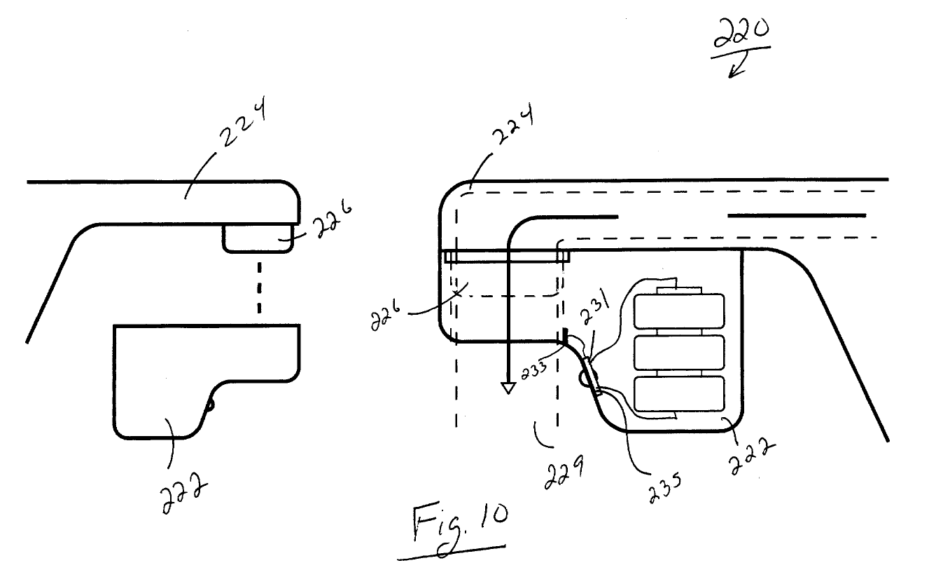

Referring now to FIG. 10, an external aerator 220 is illustrated. Aerator 220 has a pattern as shown with LED 205 in FIG. 9. In this way, the LED 231 generates a light beam that is directed into the water stream 229. The water stream is thereby illuminated, including a localized area around the water stream. The LED 231 is positioned on an aerator device housing 222. The aerator device 222 may attach to an existing aerator 226 on a faucet 224. It will be appreciated that the aerator device 222 may attach by various means, including, by adhesive, by screw or other mechanical means, or by friction. It will be appreciated that other attachment mechanisms may be used. It will also be appreciated that aerator device 222 may be integrally formed with faucet 224, or may be constructed as a replacement for existing aerator 226. In this way, external aerator 222 could threadably attach to faucet 224.

The aerator device 222 has at least one sensor 233 for detecting a condition of the water. The sensor could be for example, a flow sensor, a volume sensor, or a temperature sensor. Electronic circuitry 235 is provided for monitoring the sensor, generating a message, and activating the LED 231. Since the aerator device 222 is provided external to the faucet 224, the electronic circuitry may be powered conveniently by batteries. In another example of sensor 233, the sensor 233 may be a temperature sensor for sensing the temperature of the water in the water stream. The aerator device 222 may have predefined temperature ranges, or user controls may be provided for allowing a user to set particular temperature ranges. In this way, the LED 231 may be set to illuminate in particular temperature ranges, or may be set to display a particular color in a particular temperature range. In another example of the aerator device 222, the LED 231 is supplemented with a motion detector. In this way, the activation of power to the illumination circuit may be responsive to the motion detector detecting water flowing in the fluid stream. Alternatively, the motion sensor could be a motion sensor for detecting motion adjacent the water stream, such as when a person passes their hands beneath the faucet. In this way the illumination circuit would selectively activate to illuminate the water stream and the person's hands.

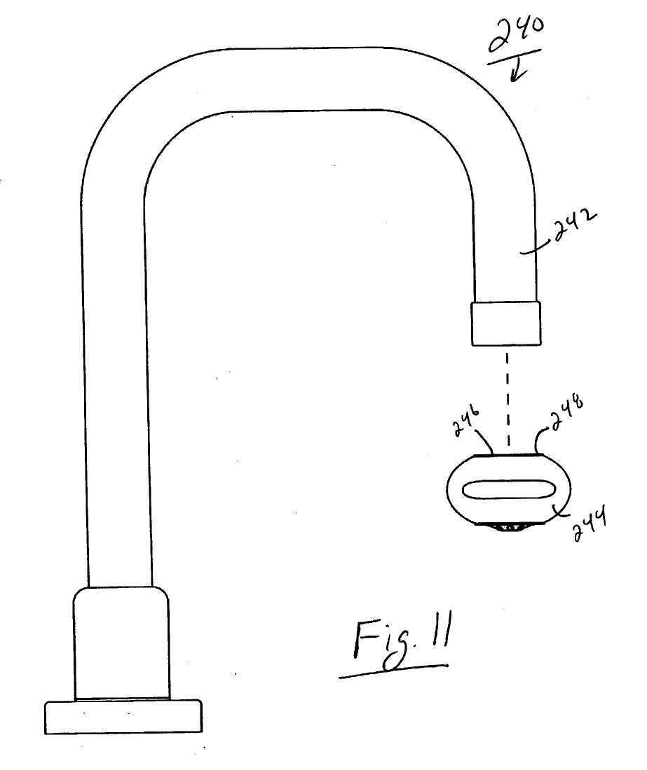

Referring now to FIG. 11, another attachable aerator is shown. The attachable aerator 240 is received onto faucet 242. The aerator 244 may be slidably received over an existing aerator and retained by friction, or, alternatively may threadably received as a replacement for the existing aerator. The attachment port 246 may contain a rubber gasket 248 for sealing and frictionally attaching to the faucet. The aerator 244 includes one or more sensors, activation circuitry, processing circuitry, and a light source consistent with previously described devices. It will be appreciated that aerator 244 may be constructed in alternative ornamental embodiments consistent with this disclosure.

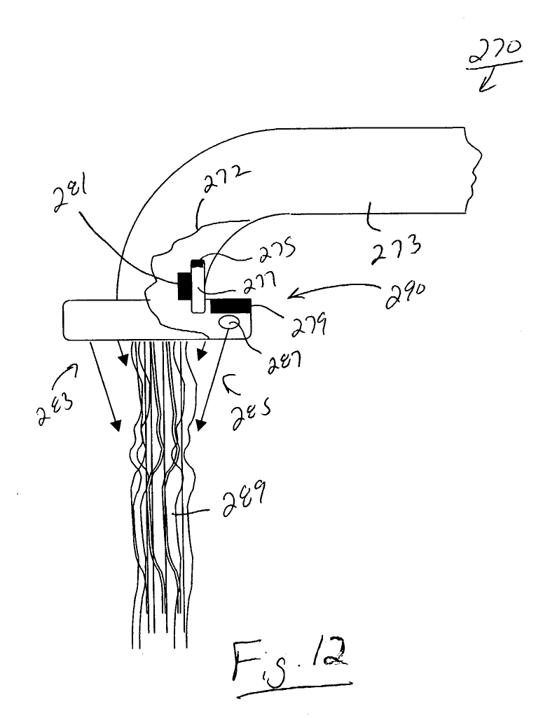

Referring now to FIG. 12 a device for monitoring and illuminating a fluid is shown. Device 270 is similar to the device described with regard to FIG. 1. Device 270 has a cutaway portion 272 for ease of description. Device 270 has a fluid inlet 273 providing a fluid to be dispensed. The fluid is dispensed into a fluid path 289. The particular fixture 290 shown in FIG. 12 is a water faucet, although it will be appreciated that other fluids and plumbing fixtures may be substituted consistent with this disclosure. Fixture 290 includes a sensor 275 for sensing a condition of the water, such as temperature. Fixture 290 does not need a flow detector, but instead has an electromagnetic generator 281. In this way, the electric generator not only may generates power when fluid is flowing, but also acts to sense when the water begins flowing and when water ceases flowing. The generator 281 generates electric power for powering the circuitry, and also may power a battery 279. Even though fixture 290 has a generator 281 a battery 279 maybe useful for providing backup or standby power. It will be appreciated that some applications may not require the use of a battery. Fixture 290 also includes a light source 283 for generating an illumination beam 285. The light source 283 may comprise one or more light sources 287, and may be for example, in the form of LED lamps. The light source 287 directs the generated illumination beam 285 into the fluid stream 289 for illuminating the fluid stream and a localized area. Circuitry for the sensing and illumination functions may be contained in a control module 277. The circuitry for control module 277 will not be described in detail, as the circuitry is similar to circuitry already described with reference to previous figures.

In initial operation, the light source 283 is off and most our all other circuitry is deactivated when no fluid is flowing. When water begins to flow through inlet 273 and is dispensed out the aerator portion of the faucet 242, the generator 281 begins to generate electricity. The presence of electricity activates the electronic circuitry and the circuitry uses sensor 275 to detect the temperature of the flowing water. The circuitry may be set to initially indicate the water is in an unsafe temperature zone to allow sufficient time for accurately sensing the temperature of the water. For example, immediately upon power up, the electronic module 277 could cause the light source 283 to illuminate the water stream with a red light beam, which would indicate an unsafe water temperature. Then, the electronic circuitry could allow sensor 275 to settle and an accurate current temperature may be obtained for the fluid. When an accurate temperature is obtained, the activation circuitry and processing circuitry would adjust to indicate when the fluid was in a safe range. For example, when the water reached a safe range, the electronic circuitry could cause the light source 283 to change to a green color, thereby indicating to the user that the water is in a safe range. When the water stops flowing, electricity would no longer be generated by generator 281, and the circuitry would be deactivated.

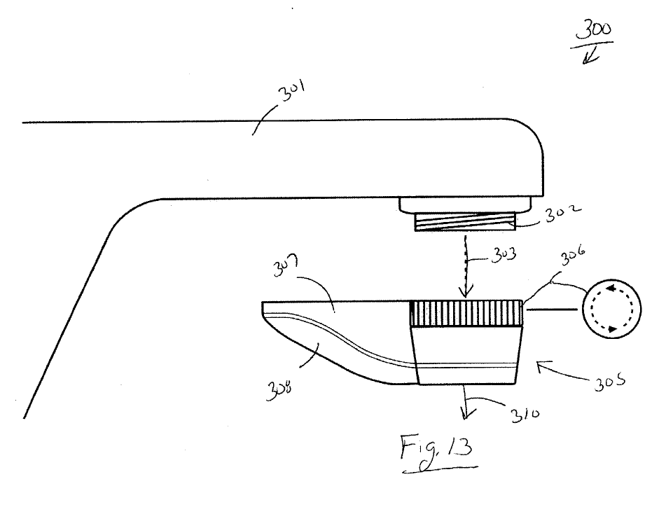

Referring now to FIG. 13, another attachable aerator system 300 is illustrated. Attachable aerator system 300 includes an attachable aerator 305 for attachment to a faucet 301. Faucet 301 has threads 302 which threadably attach to rotatable threads 306. Water flows into the attachable aerator 305 through water path 303 and is discharged through an aerator port in an aerated water stream 310. The attachable aerator 305 includes an electronic circuit area 307 for holding the electronic circuitry and light activation circuitry previously described, and a battery holding area 308 for holding a power sources, such as a AAA battery. In operation, water flows from the faucet 301 through water path 303 into the attachable aerator 305. The attachable aerator senses a condition of the water, such as the presence of a water flow, and activates the light activation circuit. An LED constructed internal to the attachable aerator directs a light beam into the aerated water stream 310 for illuminating the aerated water stream and a surrounding area. When the water ceases to flow, or the condition of the water changes, then the light may be turned off or otherwise altered.

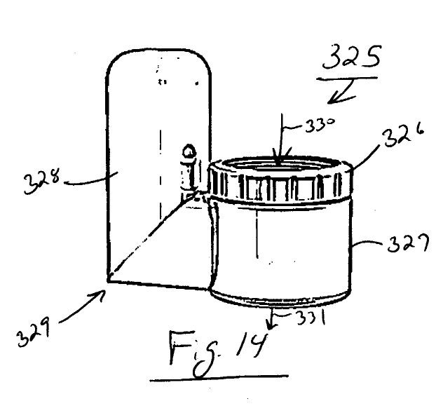

Referring now to FIG. 14, another attachable aerator 325 is illustrated. Attachable aerator 325 rotatably and threadably attaches to an existing water faucet using attachment threads 326. Attachable aerator 325 has an aerator body 327 for receiving fluid from the water faucet 330 and dispensing an aerated water stream 331 from the aerator port. A rotatable housing 329 is constructed to hold electronic circuitry, a battery, and the LED lamp. Advantageously, the rotatable housing rotates into alternative positions so that the attachable aerator 325 may attach to a wide range of standard water faucets. Irrespective of the rotation position of the rotatable housing 329, the LED lamp is directed into the aerated water stream.

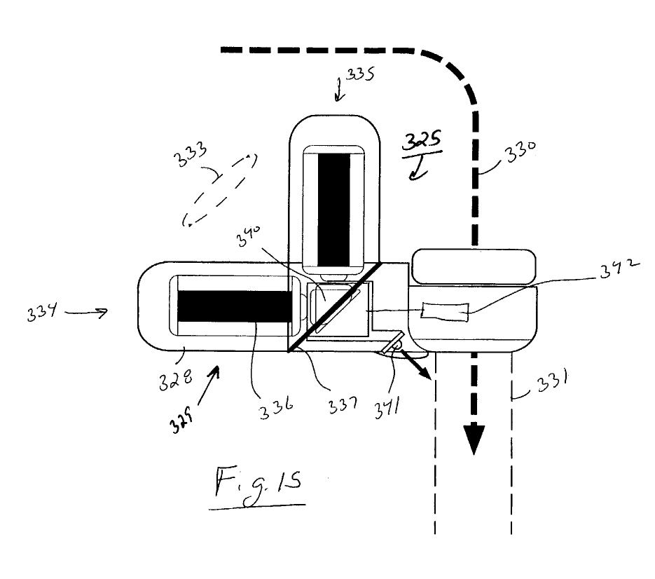

FIG. 15 shows the attachable aerator 325 of FIG. 14 in a diagrammatic form. The rotatable portion 329 is shown in two positions. First, the rotatable portion 329 is shown in a straight position 334 to minimize the height of the attachable aerator 325. In this way, the attached aerator may be attached to faucets with limited vertical space adjacent the faucet threads. The rotatable housing 329 is shown in another position 335 for minimizing the length of the attachable aerator 325. In this way, the attachable aerator 325 may be attached to water faucets having limited horizontal space adjacent to the threads, or in a situation where a vertical installation would be more aesthetically pleasing.

The attachable aerator 325 has electronic circuitry 340 coupled to sensor 342. Sensor 342 is constructed to detect the presence of a water flow, and report the detection of water flow to the electronic circuitry 340. It will be appreciated that the sensor may be positioned in the water stream or positioned out of the water stream depending on the specific construction selected for the sensor. Electronic circuitry 340 then, using activation circuitry, activates an LED 341 responsive to the detection of a water flow. Battery 336 provides power for electronic circuit, detection circuit, and LED. The battery 336 may be for example, a AAA battery or other such power source. In one implementation, rotatable housing 329 rotates from the main aerator housing on a rotation ring 337. It will be appreciated that other methods of rotating or changing housing position may be used.

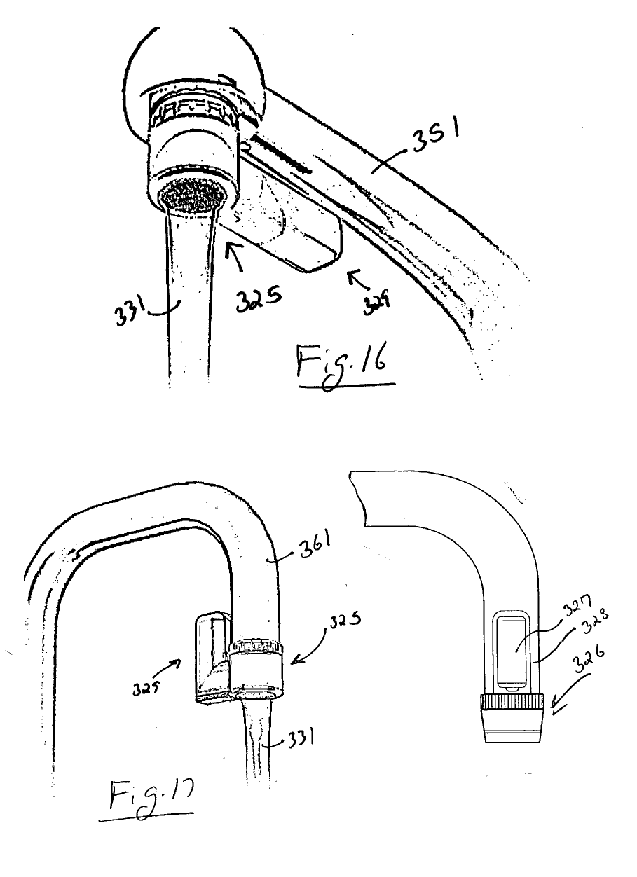

Referring now to FIG. 16, the active aerator 325 is showing threadably attached to faucet 351. Faucet 351 has limited vertical space adjacent to threads so the rotatable housing 329 is positioned to minimize the height of the active area 325. Advantageously, the active aerator 325 is positioned directly below the spout of water faucet 351 to provide and aesthetically appealing installation. When water is flowing through faucet 351, an aerated water stream 331 is ejected through the aerator port of the attachable aerator 325, and an LED in the attachable aerator provides an illumination beam into the aerator water stream 331 and also provides desirable illumination for a target area surrounding the water stream.

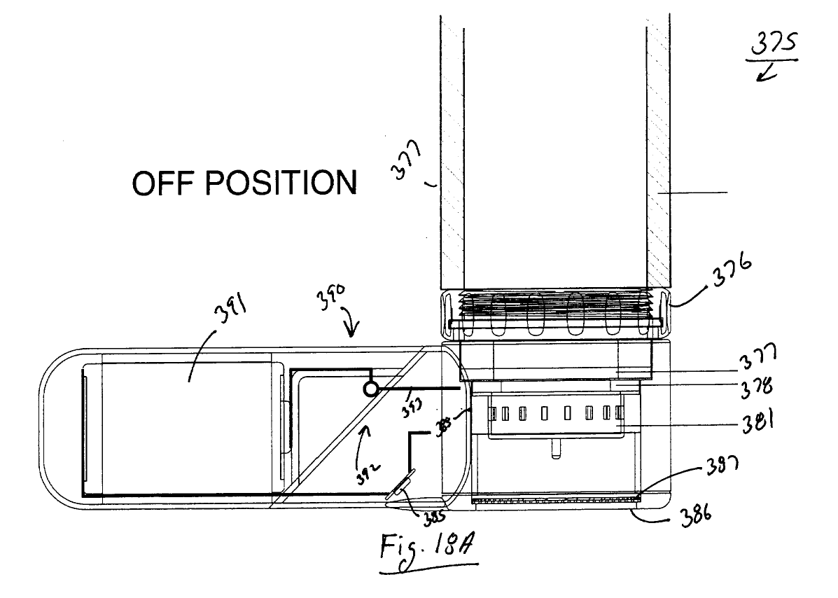

Referring now to FIG. 17 the attachable aerator 325 is shown attached to a more vertically extended water faucet 361. Water faucet 361 has ample vertical space, and therefore it may be more aesthetically appealing to limit the overall length of the attachable aerator 325. In this regard, the rotatable portion 329 is rotated into a more vertical position to limit the overall length of the attachable aerator 325. Again, the water faucet 361 provides water into the attachable aerator 325 to provide an aerated water stream 331 which is illuminated by a light beam from the LED in the attachable aerator 325.

In another example, the attachable aerator 326 couples to a vertically extended water faucet as described above. However, the battery 327 and other circuitry are held in a sealed housing 328. In this way, the battery and the other circuitry may be positioned in the water line and hidden from view, thereby providing a more aesthetically pleasing installation. To replace the battery, LED, or other circuit module, the attachable aerator is detached from the faucet, the part replace, and the attachable aerator threadably attached to the faucet.

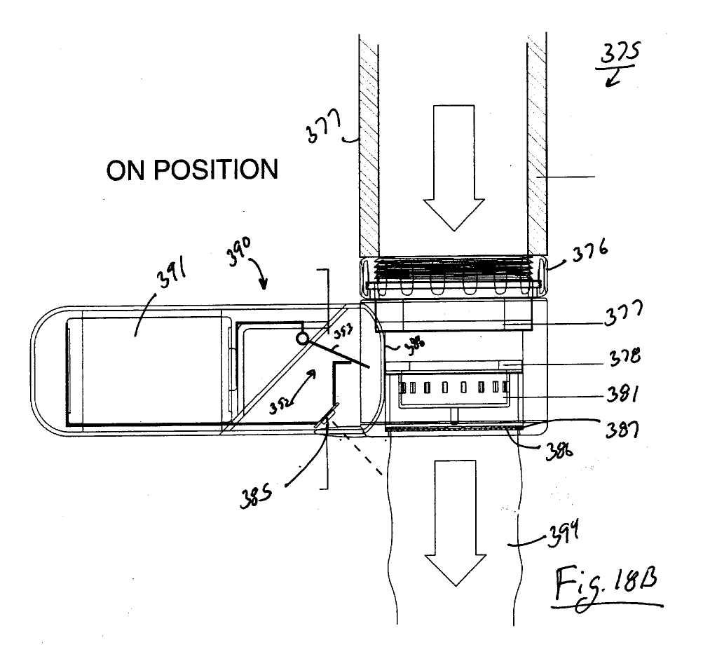

Referring now to FIG. 18a and FIG. 18b, a diagram of an attachable aerator is shown. Attachable aerator 375 couples to a water faucet 376 using rotatable threads 376. Attachable aerator 375 includes a sensor module 390 for sensing the flow of water. Advantageously, sensor 390 performs its detection and sensing function without contacting the water stream. In this way, the detection module avoids corrosion and deposit buildup normally associated with contacting household tap water. Detection module 390 includes a switch 392 having a magnetically engaged member 393. FIG. 18a shows member 393 in an open position. In the open position the circuit from the battery 391 to the LED 385 is open, and therefore the LED 385 is not illuminated. In the open position, a metallic washer 377 is attracted to a permanent magnet 378. Since the wall 388 separating the water path from the circuit housing is constructed from a non-metallic material, the magnet 378 also attracts the member 393 into the open position; however, non-magnetic materials, such as aluminum, may be substituted.

The magnet 378 is coupled to an aerator unit 381, although other physical arrangements may be substituted. When a water stream is discharged from the faucet, water pushes the aerator 381 and permanent magnet 378 away from the washer 377. The aerator 381 is pushed to contact a screen 387 in the discharge port for the attachable aerator. As the permanent magnet 378 moves toward the screen, the member 393 transitions from its off (open) position to an on (closed) position as shown in FIG. 18b. In the closed position, the battery, switch 392, and LED 385 form a closed circuit, so the LED 385 generates a light beam that is directed into the aerated water stream 394. Once the water stream stops from the water faucet, the pressure against the aerator 381 is relieved, and therefore the permanent magnet 378 is once again attracted and pulled back to the metal washer 377. The magnet 378 also attracts the member 393, thereby opening the switch 392, and deactivating the LED 385. It will be appreciated that many alternatives exist for physically implementing the structure of light activation circuitry and detecting circuitry.

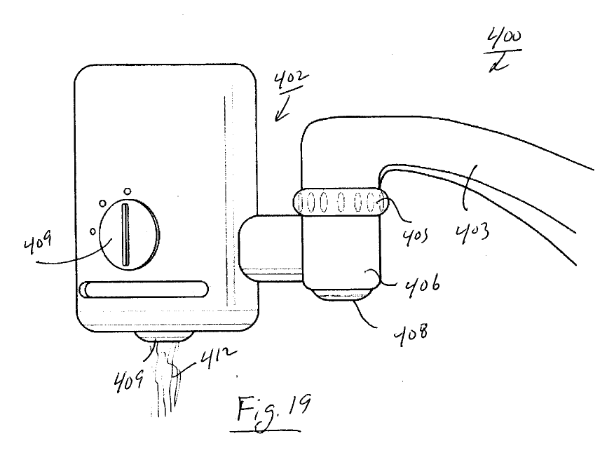

FIG. 19 shows another example of a plumbing fixture in the form of a water filter system 400. Since water filters are well known, the construction of a filter system will not be described here. Water filer system 400 has an attachable water filter 402 which attaches to faucet 403 using rotatable threads 405. When the water filter is not engaged, water flows through the aerator 406 and out unfiltered port 408. It will be appreciated that aerator 406 may include one or more sensors, control and activation circuitry, and a lamp to provide an illuminated stream consistent with this disclosure. The filter 402 has a control knob 409 for activating the filter and causing water to be diverted from the unfiltered port 408 and into the filter 402. The water flows through the filter, and flows out a filtered port 409. It will be appreciated that filter 402 may include one or more sensors, control and activation circuitry, and a lamp to provide an illuminated stream 412 consistent with this disclosure.

The sensor in filter 402 may be used to detect when filter material in the filter needs to be replaced, or when the filter is no longer providing adequate filtration. Such a sensor could be responsive to an elapsed time, to a pressure backup, to a chemical or biological level, to a control knob position, or to an accumulated volume, for example. Once the sensor detected that the filter is about to provide inadequately filtered water, the activation and control circuitry may cause a warning illumination for the user. For example, the filter 402 may illuminate filtered water with a green light to indicate safe water. When the filter is about depleted, then the illumination may turn to yellow, indicting a warning condition. And finally, when the filter is fully non-functional, the illumination may turn red, indicating a possible unsafe water condition. It will be appreciated that other messages may be communicated using combinations of colors, intensities, and patterns.

The water filter system 400 advantageously provides a user instantaneous information about the quality of filter water, and allows for the timely replacement of filters and filter parts. Further, the replaceable filter parts may include a new battery for powering the illumination circuit. In this way, the battery for the illumination circuit is replaced each time the water filter is replaced or replenished. In another example, the replaceable filter includes the sensor, activation circuit, control circuit, and lamp. Accordingly, each time the filter is replaced, the entire illumination system is also replaced. Although water filter 400 is shown with an unfiltered port and a filtered port, it will be appreciated that a single port may be used, with a control knob used to selectively activate filtration. In such a situation, the illumination system may be used to communicate the other user if the filter is active, or if unfiltered water is being dispensed. In one implementation, the sensor acts responsive to the position of the knob to select a color to illuminate the water stream. For example, when the knob is in the unfiltered position, the water stream may be illuminated red, and when the knob is in the filtered position, the water stream may be illuminated green. In this way, the user has immediate information as to the position of the knob.

While particular preferred and alternative embodiments of the present invention have been disclosed, it will be appreciated that many various modifications and extensions of the above described technology may be implemented using the teaching of this invention. All such modifications and extensions are intended to be included within the true spirit and scope of the appended claims.

What is claimed is:

1. A plumbing module, comprising;
a fluid line defining a fluid path;
a power source;
a sensor associated with the fluid path for sensing a fluid condition;
processing circuitry coupled to the sensor and generating a condition message;
a light source coupled to the power source and directed into the fluid path and constructed to generate a light beam; and
activation circuitry activating the light source so that the light beam comprises indicia indicative of the condition message.

2. The plumbing module of claim 1, wherein the activation circuitry includes a flow detector, and responsive to flowing fluid, selectively activates the light source.

3. The plumbing module of claim 1, wherein the sensor includes a temperature sensor.

4. The plumbing module of claim 3, wherein the light source is constructed to generate the light beam in a first color in a first sensed temperature range, and is constructed to generate the light beam in a second color in a second sensed temperature range.

5. The plumbing module of claim 1, wherein the sensor includes a volume sensor.

6. The plumbing module of claim 1, wherein the sensor includes a chemical sensor.

7. The plumbing module of claim 1, wherein the plumbing module includes an input port constructed to receive a faucet.

8. The plumbing module of claim 1, wherein the plumbing module includes a faucet, and the sensor and light source are formed integrally to the faucet.

9. The plumbing module of claim 1, wherein the light source is constructed to generate the light beam in a first color in a first sensed fluid condition, and is constructed to generate the light beam in a second color in a second sensed fluid condition.

10. The plumbing module of claim 1, wherein the light source is constructed to generate the light beam in a first intensity in a first sensed fluid condition, and is constructed to generate the light beam in a second intensity in a second sensed fluid condition.

11. The plumbing module of claim 1, wherein the light source is constructed to generate the light beam in a first flash pattern in a first sensed fluid condition, and is constructed to generate the light beam in a second flash pattern in a second sensed fluid condition.

12. The plumbing module of claim 1, wherein the power source is a battery integral to the plumbing module.

13. The plumbing module of claim 1, wherein the power source is a battery attached to the plumbing module.

14. The plumbing module of claim 1, wherein the power source is an electrical generator powered by flowing fluid.

15. The plumbing module of claim 1, further including a filter having a filtered port, with the fluid path arranged to extend through the filtered port, and the sensor is constructed to detect the filter condition of the fluid.

16. A water fixture, comprising:
an aerator port for dispensing water in an aerated stream;
a light source coupled to the aerator port and positioned to direct a light beam into the aerated stream;
a sensor positioned to detect a condition;
processing circuitry to generate a message indicative of the condition; and
a switch coupled to the processing circuitry and arranged to activate the light source;
wherein the light source generates the light beam comprising the message.

17. The water fixture of claim 16, wherein the light source is positioned in the stream.

18. The water fixture of claim 16, wherein the light source is positioned adjacent the stream.

19. The water fixture of claim 16, wherein the sensor is in the water stream for detecting a water characteristic.

20. A method of presenting a water condition, comprising:
dispensing a fluid in a fluid path;
sensing a fluid condition;
generating a message indicative of the fluid condition;
generating a light beam comprising the message; and
directing the light beam into the fluid path.

21. The method according to claim 20, wherein the generating step includes generating the message to comprise an indication that the fluid is flowing.

22. The method according to claim 20, wherein the generating step includes generating the message to comprises an indication of the fluid temperature.

23. The method according to claim 20, wherein the generating step includes generating the message to comprise an indication of contaminates in the fluid.
